(19) United States
(12) Patent Application Publication
(10) Pub. No.: US 2011/0225875 A1
(43) Pub. Date: Sep. 22, 2011

(54) Wood-Based Termite Bait System

(75) Inventor: Jeffrey Douglas Lloyd, Knoxville, TN (US)

(73) Assignee: NISUS CORPORATION, Rockford, TN (US)

(21) Appl. No.: 13/049,020

(22) Filed: Mar. 16, 2011

Related U.S. Application Data
(60) Provisional application No. 61/314,306, filed on Mar. 16, 2010.

(51) Int. Cl. A01M 1/20

(52) U.S. Cl. 43/131

(57) ABSTRACT

The present disclosure provides a termite bait station. In one embodiment, the termite bait station includes a bait article made of a cellulosic material such as wood. Preferred woods include rubber wood, spruce wood, aspen wood, pine wood, poplar wood, sweet gum wood, eucalyptus wood and mango wood. The bait article includes a first end surface and a second end surface, an outer surface, at least one insecticide reservoir disposed in the bait article and a second end surface, and at least one termite feeding channel disposed in the outer surface. The termite bait station also includes an insecticide-fungicide mixture disposed within the insecticide reservoir. At least a portion of the insecticide-fungicide mixture from the reservoir diffuses into the wood of the bait article. A method for reducing termite infestation using the termite bait stations is also disclosed.

### CROSS-REFERENCE TO RELATED APPLICATIONS

This application claims the benefit of the earlier filing date of provisional application 61/314,306, filed Mar. 16, 2010.

### FIELD

The present disclosure relates in general to systems for pest control, in particular, to a termite bait station.

### BACKGROUND

Various wood-based termite bait stations are known in the prior art. However, there is a continuing need for improved bait stations having improved effectiveness in attracting and killing termites while, at the same time, employing a minimal amount of insecticides which are toxic to humans and/or environmentally undesirable. It is also desirable that a wood-based termite bait station be resistant to decay from fungi when left in a moist subterranean environment.

### SUMMARY

In a first aspect, the present disclosure provides a termite bait station. In one embodiment, the termite bait station includes a bait article made from a cellulosic material. For instance, the cellulosic material may be made of wood. The bait article includes a first end surface and a second end surface, an outer surface, and at least one insecticide reservoir disposed within the cellulosic material of the bait article. The termite bait station also includes an insecticide-fungicide mixture disposed within the insecticide reservoir. The insecticide-fungicide mixture is composed of at least one form of borate. At least a portion of the insecticide-fungicide mixture from the reservoir diffuses into the wood of the bait article.

In certain embodiments of the bait station, the cellulosic material is preferably made from at least one type of wood selected from the group consisting of rubber wood, spruce wood, aspen wood, pine wood, poplar wood, sweet gum wood, eucalyptus wood and mango wood. More preferably, the cellulosic material is made from wood from the Hevea brasiliensis tree.

In certain embodiments of the bait station, the bait article is generally cylindrical in shape, having a diameter of from about 10 mm to about 300 mm and a height of from about 10 mm to about 300 mm. However, in certain other embodiments of the bait station, the bait article is generally prismatic in shape. In still other embodiments, the bait article is generally semi-cylindrical in shape. The bait article preferably has an oven dry weight of from about 50 grams to about 2000 grams.

In certain embodiments of the bait station, the bait article preferably includes at least one, and up to, termite feeding channels disposed in the outer surface of the bait article. In some embodiments, the bait article preferably includes up to four termite feeding channels. In still other embodiments, the bait article preferably includes up to sixteen termite feeding channels. Further, in some embodiments according to the present disclosure, the termite feeding channel has a cross-sectional area of from about 1 to about 10 square millimeters.

In certain embodiments of the bait station, the insecticide-fungicide mixture is preferably made up of a first active component which functions as an insecticide and a second active component which functions as a fungicide. However, in other embodiments of the bait station, the insecticide-fungicide mixture is preferably made up of an active component which functions as both an insecticide and as a fungicide.

For instance, the insecticide-fungicide mixture may preferably include at least one form of borate selected from the group consisting of boric acid, boric oxide, metal borate salts, non-metallic borate compounds, and mixtures thereof. More preferred forms of borate include boric acid, boric oxide, sodium tetraborate, and disodium octaborate. In some embodiments of the bait station, the insecticide-fungicide mixture is also preferably composed of from about 0.05 to about 0.45 weight percent disodium octaborate tetrahydrate, and more preferably of from about 0.1 to about 0.3 weight percent disodium octaborate tetrahydrate.

In some instances, the insecticide reservoir may be formed by one or more cavities disposed within the bait article having a total volume of from about 0.05 to about 60 milliliters. In some embodiments of the bait station, the insecticide-fungicide mixture also preferably includes at least one hygroscopic agent selected from the group consisting of glycols, glycerine, and salts. For instance, the one hygroscopic agent may be selected from the group consisting ethylene glycol, diethylene glycol, triethylene glycol, tetraethylene glycol, polyethylene glycol, propylene glycol, dipropylene glycol, tripropylene glycol, tetrapropylene glycol, polypropylene glycol, glycerine, and mixtures thereof.

Preferably, the diffusion of the insecticide-fungicide mixture provides a borate concentration in the wood at the outer surface of the bait article which is substantially nonrepellant to termites and a borate concentration in at least a portion of the interior wood of the bait article which is substantially toxic to termites.

In a second aspect, the present disclosure provides a method for reducing termite infestation. In one embodiment, the method uses a plurality of termite bait stations. Each of the termite bait stations includes a bait article made from a cellulosic material. For instance, the cellulosic material may be made of wood. The bait article includes a first end surface and a second end surface, an outer surface, and at least one insecticide reservoir disposed within the cellulosic material of the bait article. The termite bait station also includes an insecticide-fungicide mixture disposed within the insecticide reservoir. The insecticide-fungicide mixture is composed of at least one form of borate. At least a portion of the insecticide-fungicide mixture from the reservoir diffuses into the wood of the bait article. According to the method, a plurality of the termite bait stations are positioned within an area which is infested with termites. The termites then consume at least a portion of the wood from the bait article and thereby ingest a toxic amount of borates.

In certain embodiments of the method according to the present disclosure, the cellulosic material is preferably made from at least one type of wood selected from the group consisting of rubber wood, spruce wood, aspen wood, pine wood, poplar wood, sweet gum wood, eucalyptus wood and mango wood. More preferably, the cellulosic material is made from wood from the Hevea brasiliensis tree.

In certain embodiments of the method according to the present disclosure, the bait article is generally cylindrical in shape, having a diameter of from about 10 mm to about 300 mm and a height of from about 10 mm to about 300 mm. However, in certain other embodiments of the method according to the present disclosure, the bait article is generally prismatic in shape. In still other embodiments, the bait article is generally semi-cylindrical in shape. The bait article preferably has an oven dry weight of from about 50 grams to about 2000 grams.

In certain embodiments of the method of the present disclosure, the bait article preferably includes at least one termite feeding channels disposed in the outer surface of the bait article. In some embodiments, the bait article preferably includes up to four termite feeding channels. In still other embodiments, the bait article preferably includes up to sixteen termite feeding channels. Further, in some embodiments according to the present disclosure, the termite feeding channel has a cross-sectional area of from about 1 to about 10 square millimeters.

In certain embodiments of the method of the present disclosure, the insecticide-fungicide mixture is preferably made up of a first active component which functions as an insecticide and a second active component which functions as a fungicide. However, in other embodiments of the method, the insecticide-fungicide mixture is preferably made up of an active component which functions as both an insecticide and as a fungicide.

For instance, the insecticide-fungicide mixture may include at least one form of borate selected from the group consisting of boric acid, boric oxide, metal borate salts, non-metallic borate compounds, and mixtures thereof. More preferred forms of borate include boric acid, boric oxide, sodium tetraborate, and disodium octaborate. In some embodiments of the method, the insecticide-fungicide mixture is also preferably composed of from about 0.05 to about 0.45 weight percent disodium octaborate tetrahydrate, and more preferably of from about 0.1 to about 0.3 weight percent disodium octaborate tetrahydrate. In some instances, the insecticide reservoir may be formed by one or more cavities disposed within the bait article having a total volume of from about 0.05 to about 60 milliliters.

In some embodiments of the method, the insecticide-fungicide mixture also preferably includes at least one hygroscopic agent selected from the group consisting of glycols, glycerine, and salts. For instance, the one hygroscopic agent may be selected from the group consisting ethylene glycol, diethylene glycol, triethylene glycol, tetraethylene glycol, polyethylene glycol, propylene glycol, dipropylene glycol, tripropylene glycol, tetrapropylene glycol, polypropylene glycol, glycerine, and mixtures thereof.

Preferably, the diffusion of the insecticide-fungicide mixture provides a borate concentration in the wood at the outer surface of the bait article which is substantially nonrepellant to termites and a borate concentration in at least a portion of the interior wood of the bait article which is substantially toxic to termites.

In a further aspect, the present disclosure provides a termite bait station. In one embodiment, the termite bait station includes a bait article made from a cellulosic material. The bait article includes a first end surface and a second end surface, an outer surface, at least one insecticide reservoir disposed within the cellulosic material of the bait article, and a plurality of termite feeding channels disposed in the outer surface. Each of the termite feeding channels has a cross-sectional area of from about 1 to about 10 square millimeters. The at least one insecticide reservoir has a total volume of from about 0.05 to about 60 milliliters. The termite bait station also includes an insecticide-fungicide mixture disposed within the insecticide reservoir. The insecticide-fungicide mixture is composed of at least one form of borate. At least a portion of the insecticide-fungicide mixture from the reservoir diffuses into the cellulosic material of the bait article.

In certain embodiments according to the present disclosure, the cellulosic material is preferably made from at least one type of wood selected from the group consisting of rubber wood, spruce wood, aspen wood, pine wood, poplar wood, sweet gum wood, eucalyptus wood and mango wood. More preferably, the cellulosic material is made from wood from the Hevea brasiliensis tree.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a perspective view of a bait article in accordance with one embodiment of the present disclosure;

FIG. 2 is a perspective view of a bait article in accordance with a second embodiment of the present disclosure;

FIGS. 3a and 3b are perspective views of a bait article in accordance with a further embodiment of the present disclosure; and

FIGS. 4a and 4b are perspective views of a bait article in accordance with a yet another embodiment of the present disclosure.

### DETAILED DESCRIPTION

In one regard, the present disclosure provides a termite bait station. According to one embodiment, the termite bait station includes a bait article made from a cellulosic material. The cellulosic material used in the bait article may be composed of solid wood, or a composite material made at least in part from wood, or a material made up at least in part of processed cellulosic fibers (such as paper or fiberboard).

In general, the bait article is preferably composed of solid wood. Preferred woods for use in the bait article may be wood selected from the group consisting of rubber wood, spruce wood, aspen wood, pine wood, poplar wood, sweet gum wood, eucalyptus wood and mango wood. In certain embodiments, the bait article is more preferably made from the wood of the Hevea brasiliensis tree, commonly referred to as the “rubber wood” tree. In some embodiments, the bait article may be composed entirely of rubber wood. In other embodiments, a portion of the bait article may be composed of rubber wood, with other portions of the bait article being composed of other wood species and/or non-wood materials.

The aforementioned wood species have been observed to be particularly attractive to termites. In addition, the wood species have been found to have improved fungi resistance when the wood is injected with an insecticide-fungicide mixture in accordance with the present disclosure.

In some instances, at least a portion of the bait article may be composed of wood which has previously been infested with fungi.

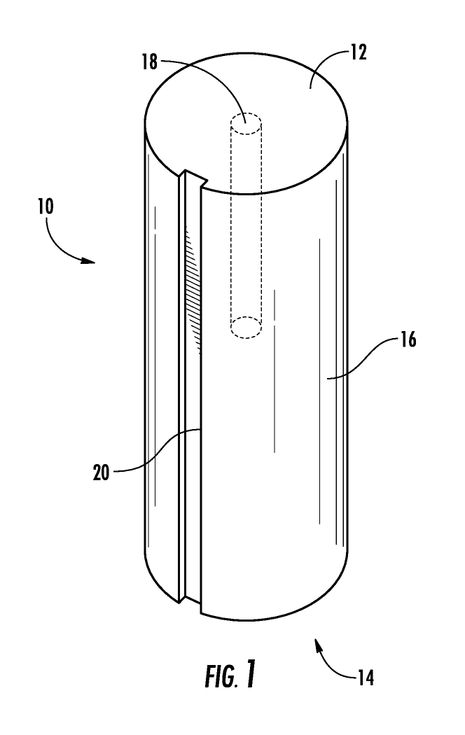

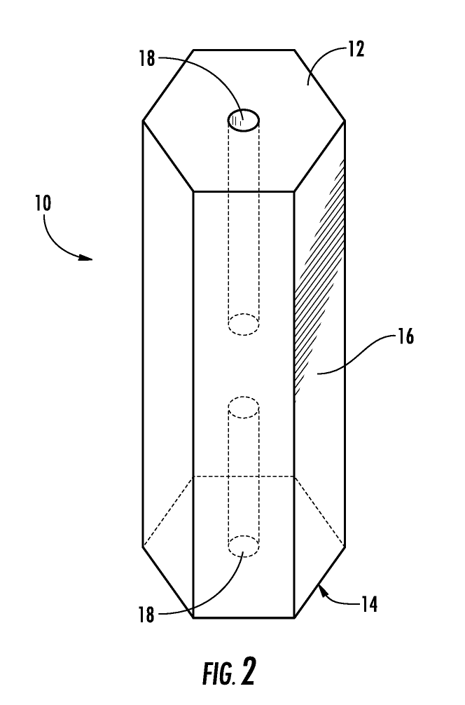

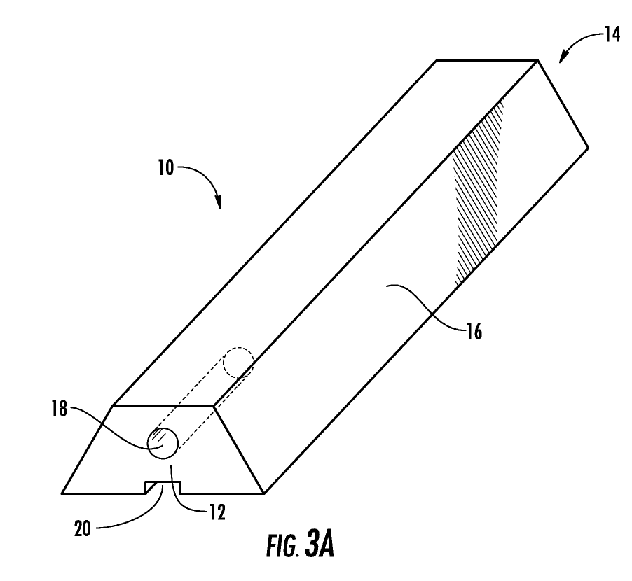

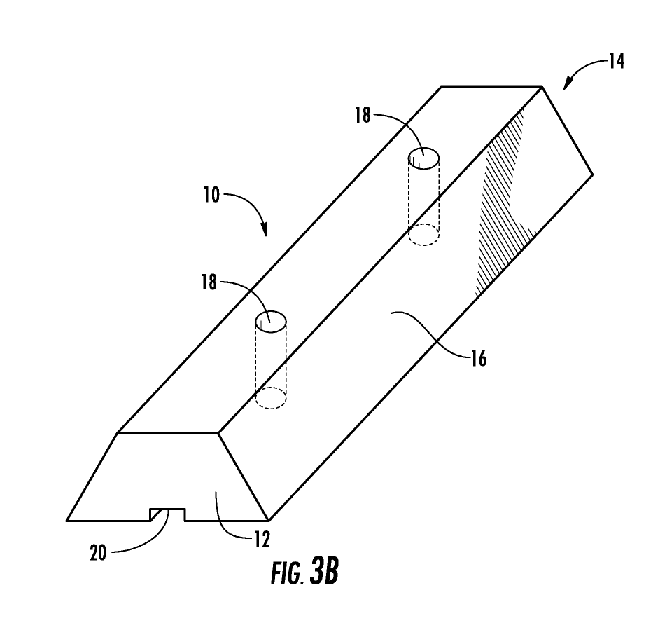

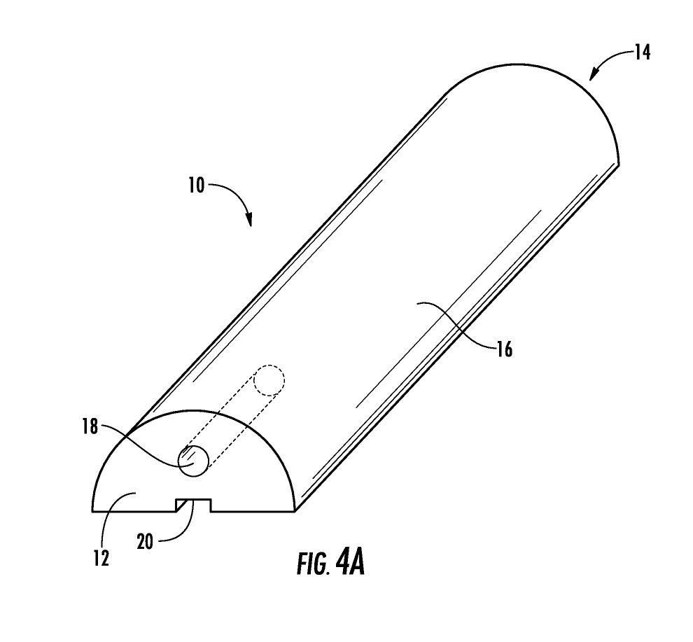

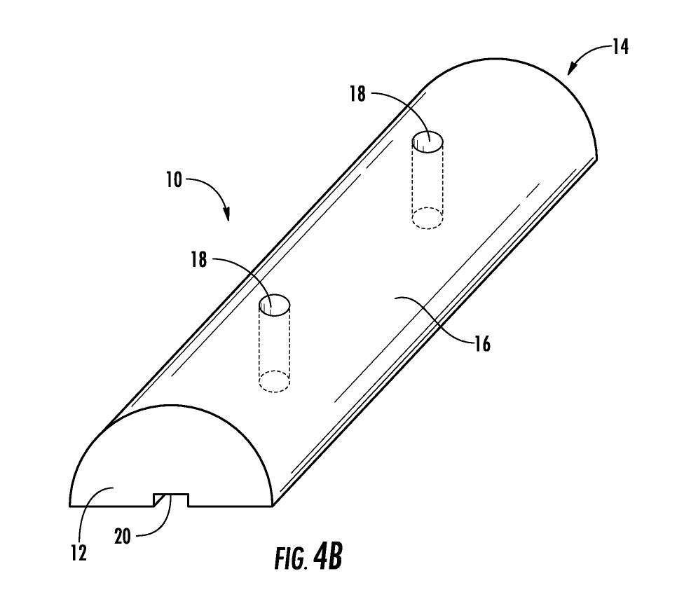

As shown in FIGS. 1-4, the bait article 10 includes a first end surface 12 and a second end surface 14, an outer surface 16, and at least one insecticide reservoir 18 located within the bait article. The bait article generally also includes at least one termite feeding channel disposed in the outer surface. In some embodiments, the bait article 10 is generally cylindrical in shape as shown in FIG. 1, having a diameter of from about 10 mm to about 300 mm and a height of from about 10 mm to about 300 mm. However, in other embodiments, the bait article 10 is generally prismatic in shape, as shown in FIG. 2 and FIGS. 3a and 3b. In still other embodiments, the bait article is generally semi-cylindrical in shape as shown in FIGS. 4a and 4b. In yet another embodiment, the overall bait article may be made up of a plurality (e.g. three) separate pieces of wood, with each piece of wood having a generally cubical or rectangular box shape.

The weight (on an oven dry basis) of the bait article is generally from about 50 grams to about 3000 grams.

The bait article 10 may include at least one termite feeding channel 20 disposed in the outer surface 16 of the bait article 10. Generally, the bait article includes a plurality of termite feeding channels disposed in the outer surface of the bait article. In some embodiments, the bait article preferably includes up to four termite feeding channels disposed in the outer surface of the bait article. In still other embodiments, the bait article preferably includes up to sixteen termite feeding channels.

At least one, and preferably each, of the termite feeding channels generally has a cross-sectional area of from about 1 to about 10 square millimeters. Termites generally desire a moist, enclosed environment. Therefore, when moving over open, exposed surfaces, termites often create “shelter” tubes from mud to travel within. These shelter tubes provide the moist protected environment desired by the termites. Without being bound by theory, it is believed that termite feeding channels having a cross-sectional area of from about 1 to about 10 square millimeters are conducive to the formation of termite shelter tubes and feeding and that termites actually prefer to form shelter tubes in such channels. Alternatively, the bait article may be formed from a plurality of smaller pieces of wood with these smaller wood pieces positioned so that the gaps formed the between pieces of wood are also conducive to the formation of termite shelter tubing.

As noted above, at least one insecticide reservoir 18 is located within the bait article 10. Preferably, the insecticide reservoir 18 may be formed by one or more cavities disposed within the first end surface 12 and/or the second end surface 14. The total volume of the insecticide reservoir 18 is generally from about 0.05 to about 60 milliliters, and is more preferably from about 2 to about 10 milliliters.

An insecticide-fungicide mixture is disposed within the insecticide reservoir. Preferably, the insecticide-fungicide mixture is injected into the reservoir.

As used herein, an “insecticide-fungicide mixture” is a composition which is substantially toxic to (i.e., kills or controls) both insects and fungi. In instances the insecticide-fungicide mixture may include an insecticide component and a separate fungicide component. In other embodiments, the insecticide-fungicide mixture includes a single active ingredient which functions as both an insecticide and a fungicide.

In embodiments wherein the insecticide-fungicide mixture includes an insecticide component and a separate fungicide, preferred insecticides include sulfluramid, noviflumuron, hexaflumuron, diflubenzuron, hydramethylnon and borates. Preferred fungicides include azoles (such as tebuconazole and propiconazale), quaternary ammonium compound (such as diecyl dimethyl ammonium chloride) chlorothalonil, carbamates (such as iodopropynyl butylcarbamate), organic or inorganic copper-based preservatives (such as chromated copper arsenate) and borates.

More preferably, however, the insecticide-fungicide mixture includes a single active ingredient which functions as both an insecticide and a fungicide. For instance, various forms of borates may be used in the insecticide-fungicide mixture to provide both insecticidal activity and fungicidal activity. More particularly, the insecticide-fungicide mixture may include one or more forms of borate selected from the group consisting of boric acid, boric oxide, metal borate salts, non-metallic borate compounds, and mixtures thereof.

Suitable metal borate salts include borate salts of lithium, sodium, potassium, magnesium, calcium, barium, zinc, and copper. The borate salts may include more than one metal species. For example, the metal borate salt may be a sodium calcium borate such as ulexite). Suitable non-metallic borate compounds include silicon borates and organic borates such as boronic and borinic acids or boresters. More preferred forms of borate include boric acid, boric oxide, sodium tetraborate, sodium pentaborate, sodium hexaborate and disodium octaborate. In some embodiments, the insecticide-fungicide mixture preferably includes disodium octaborate. The concentration of the disodium octaborate in the mixture is generally from about 0.05 to about 0.45 weight percent disodium octaborate tetrahydrate and more preferably from about 0.1 to about 0.3 weight percent disodium octaborate tetrahydrate.

A concentration of disodium octaborate from about 0.05 to about 0.45 weight percent disodium octaborate is equivalent (in terms of the amount of elemental boron) to a concentration of boric oxide (B₂O₃) from about 0.03 to about 0.3 weight percent. If other borates are used with, or in substitute, for disodium octaborate, then the overall concentration of borates added is preferably equivalent to a concentration of boric oxide from about 0.03 to about 0.3 weight percent.

A borate-based insecticide-fungicide may be provided in any of a variety of forms. Generally, the borate-based insecticide-fungicide is generally provided as a solid-form borate. Solid forms are preferred since they are less likely to fall or spill out of the bait article if it is inverted. In some instances, however, the borate-based insecticide-fungicide may also be provided as a liquid.

For instance, the borate material may be heated to a very high temperature of about 800° C. or more and fused into a glasslike solid rod or tablet. Alternatively, the borate material may be heated to a lower temperature of about 200° C. and fused into a solid rod or tablet having a plastic-like appearance. The borate material may also be pressed into a solid rod or tablet using an appropriately shaped die press.

The borate-based insecticide-fungicide may also be provided as a liquid, preferably a liquid which ultimately sets to form a solid. For example, borate-based insecticide-fungicide may be a borate dissolved in a high molecular weight poly glycol that subsequently sets to a solid at room temperature. A dehydrated borate could also be mixed with water, as the borate will subsequently absorb the water and rehydrate and recrystallize leaving only a solid form. Similarly a mixture of boric acid, borax (sodium tetraborate), and water could also be used. This initially liquid mixture will also react and ultimately form a solid mass of borates.

A particularly preferred liquid form for the borate is a micromicellar emulsion of made up of sodium pentaborate in water. This emulsion may be injected into the reservoir in liquid form and allowed to dry to a solid form at room temperature. Advantageously, the emulsion will also penetrate into at least a portion of the bait article wood before solidifying.

The insecticide-fungicide mixture may also include at least one hygroscopic agent selected from the group consisting of a glycol or sugar alcohols or salts. The insecticide-fungicide mixture preferably may also include at least one hygroscopic agent selected from the group consisting of ethylene glycol, diethylene glycol, triethylene glycol, tetraethylene glycol, polyethylene glycol, propylene glycol, dipropylene glycol, tripropylene glycol, tetrapropylene glycol, polypropylene glycol, glycerine, and mixtures thereof. Water repellents or leaching retardants may also be included in the insecticide-fungicide mixture.

In addition, the insecticide-fungicide mixture may also include a minor amount of nutrients or vitamins which support the growth of fungi (and directly or indirectly termites). For instance, the insecticide-fungicide mixture may also supply nutrients such as nitrogen, phosphorous, and potassium (NPK) as well as micronutrients such as are manganese, boron, sulfur, copper, iron, chlorine, cobalt, molybdenum, and zinc. Vitamins such as thiamine may also be included. The addition of such nutrients to an insecticide-fungicide may appear to be counterintuitive; however, it is believed that a limited, controlled amount of fungi growth acts as an attractant to termites. Such limited growth may be achieved by combining both nutrients and a fungicide in the mixture.

In some instances, the nutrients will generally diffuse from the reservoir and through the wood more quickly than the fungicide. Accordingly, a limited amount of fungi growth is initially permitted around the outer surfaces of the bait article as the nutrients diffuses to these areas first. When the fungicide later diffuse to the outer portions of the bait article, however, further fungal growth is suppressed.

Further, the insecticide-fungicide mixture may also include one or more termite attractant chemicals. For instance, extractives from fungi-infested wood may be included in the insecticide-fungicide mixture according to certain embodiments of the present invention. Such extractives may be included in the insecticide-fungicide mixture according to certain embodiments of the present invention. Particularly preferred are extractives from wood infested with Basidiomycete fungi (such brown rot decay fungi and/or white rot decay fungi) Ascomycetes fungi or Deuteromyctes fungi (such as mold fungi).

Once the insecticide-fungicide mixture is poured into the reservoir, at least a portion of the insecticide-fungicide mixture diffuses from the reservoir into the wood of the bait article. Thus, when termites consume wood from the bait station, they also ingest any insecticide which has diffused into the wood.

As the insecticide-fungicide mixture diffuses outwardly from the insecticide reservoir towards the outer surface of the bait article, it will be appreciated that an insecticide concentration gradient is established in wood of the bait article. The concentration of insecticide is greatest in the wood near the center of the bait article, and the concentration of insecticide is lowest in the wood near the outer surface of the bait article.

Advantageously then, the diffusion of the insecticide-fungicide mixture preferably provides a borate concentration in the wood at the outer surface of the bait article which is substantially nonrepellant to termites and a borate concentration in at least a portion of the interior wood off the bait article which is substantially toxic to termites. The nonrepellant insecticide concentration near the outer surface of the bait article, combined with the particular attractiveness of the wood species used in the bait article, results in a bait station having an improved attractiveness to nearby termites. That is, the bait station is more quickly found by termites and/or a larger portion of the wood from the bait station is consumed by the termites.

As a further advantage, it has also been found that diffusion of the insecticide-fungicide mixture from the reservoir also reduces the leaching rate (removal of the termiticide and fungicide) of the active ingredients as compared to application of an insecticide to only the outer surfaces of a bait article. This reduction in leaching removal rate leads to a longer efficacy for the bait article.

As a further benefit, injection of the insecticide-fungicide mixture has also been observed to make the wood of the bait article more resistant to fungal decay.

The present disclosure also provides a method for reducing termite infestation. According to the method, a plurality of termite bait stations as described above, are provided and set out within an area which is infested with termites. The termites then consume at least a portion of the wood from the bait article and thereby ingest a toxic amount of borates.

In some instances, the termite bait station also includes a small plastic or other inert enclosure or cage, having a plurality of holes for termite ingress and egress. The bait article is placed within this cage. A small hole is then dug in the ground and the cage, with the bait station, is placed in the hole in the ground. In other instances, the bait station may be placed on the ground. In still other instances, the bait station may be placed underneath mulch or attached to the side of a home or other building or placed within the home or building.

Within the termite infested area, the termite bait stations are preferably positioned from about 2 to about 100 feet apart from adjacent termite bait stations. Generally, a total of from about 5 to about 40 bait stations are needed to effectively combat termite infestations around the perimeter of a structure which is from about 1000 to about 3000 square feet in size.

### EXAMPLES

### Example 1

### Attractiveness of Rubber Wood to Coptotermes gestroi

In this Example, wood from the rubber wood tree (Hevea brasiliensis) was compared to wood from the raintree (Albizia saman) and the mango tree (Mangifera indica) to determine the relative attractiveness of the different woods to termites of the species Coptotermes gestroi. This experiment was carried out in Bangkok, Thailand.

Cylindrical samples of each type of wood, approximately measuring 62 mm diameter by 72 mm length were prepared. Each block also had 4 termite feeding tracks 3 mm wide and 5 mm deep cut longitudinally on each compass point of the block to facilitate building of termite feeding tubes. None of the samples were treated with any form of insecticide and/or fungicide.

A total of five samples of each type of wood was placed outdoors in an area known to be infested with Coptotermes gestroi termites for a period of 25 days. The wood samples were placed on top of a crack in a concrete slab, rather than sitting directly on soil and were protected by roof. This was done to minimize moisture absorption from the soil and any accompanying fungal decay during this study.

Each wood sample was weighed at the beginning of the study, and again at the end of 25 days. The results are as follows:

Rainwood Tree

| | Initial Wt. | Wt. after 25 days | |
|---|---|---|---|
| Sample No. | (grams) | (grams) | % Weight Change |
| 1 | 150.40 | 155.6 | +3.46 |
| 2 | 170.60 | 179.6 | +5.28 |
| 3 | 176.60 | 183.4 | +3.85 |
| 4 | 173.30 | 179.1 | +3.35 |
| 5 | 154.10 | 160 | +3.83 |
| Average | | | +3.95 |

Rubber Wood Tree

| | Initial Wt. | Wt. after 25 days | |
|---|---|---|---|
| Sample No. | (grams) | (grams) | % Weight Change |
| 1 | 105.70 | 64.4 | −39.07 |
| 2 | 96.40 | 59.5 | −38.28 |
| 3 | 99.20 | 80.8 | −18.55 |
| 4 | 99.00 | 96.2 | −2.83 |
| 5 | 102.10 | 60.6 | −40.65 |
| Average | | | −27.87 |

Mango Wood

| | Initial Wt. | Wt. after 25 days | |
|---|---|---|---|
| Sample No. | (grams) | (grams) | % Weight Change |
| 1 | 149.10 | 151.6 | +1.68 |
| 2 | 161.60 | 165.4 | +2.35 |
| 3 | 147.90 | 149.6 | +1.15 |
| 4 | 149.00 | 152.4 | +2.28 |
| 5 | 162.70 | 165.3 | +1.60 |
| Average | | | +1.81 |

These results show that the rubberwood samples were consistently attacked and consumed by the termites at a much higher rate than either the raintree wood or the mango wood samples. With the 5 rubber wood samples, an average of nearly 28% of the wood was consumed by the termites in only 25 days. In comparison, each of the raintree and mango wood samples showed a small increase in weight after 25 days. This increase in weight indicates that the weight loss from any wood consumed by termites during this time was more than offset by weight gains due to moisture absorption from the environment and/or mud being applied to the wood samples by the termites.

### Example 2

### Attractiveness of Rubber Wood to Reticulitermes sp

In this Example, wood from the rubber wood tree (Hevea brasiliensis) was compared to wood from the pine (Pinus sp.) and the aspen tree (Populus sp.) to determine the attractiveness of the different woods to termites of the species Reticulitermes. This experiment was carried out in Lisbon, Portugal.

Cylindrical samples of rubberwood, approximately measuring 62 mm diameter by 72 mm length were prepared. Each block also had 4 termite feeding tracks 3 mm wide and 5 mm deep cut longitudinally on each compass point of the block to facilitate building of termite feeding tubes. These were compared to commercially available termite baits based on pine and aspen. (Dow SENTRICON and Whitmire ADVANCE). A total of five samples of each type of system was placed outdoors in an area known to be infested with Reticulitermes termites for a period of 3 months. The rubberwood was place in plastic cages in the ground and the commercial systems placed in the ground also.

Each system was inspected weekly but at alone week and two weeks, two of the rubberwood baits already showed termite activity but none of the commercial systems had. This showed that termites preferentially preferred rubberwood as a food material or that it was somehow easier to find or more attractive.

### Example 3

### Mold/Fungal Growth in Treated Rubber Wood Blocks

In this example, three rubber wood (Hevea braziliensis) cylindrical blocks designed to attract termites, each measuring 62 mm diameter by 72 mm length, (weighing approximately 150 g), were injected with 1.5 ml of a 40 weight percent disodium octaborate tetrahydrate (DOT), poly glycol composition (commercially available as Bora-Care, EPA registration No.: 64405-1). The composition was injected into a center drilled hole of 4 mm diameter with a depth of approximately ¾ of the block, in order to achieve an overall retention of about 0.4 weight percent DOT in the wood on an oven dry weight basis. Each block also had 4 termite feeding tracks 3 mm wide and 5 mm deep cut longitudinally on each compass point of the block along the longest surface.

The blocks were then placed in a humidity chamber at 90 to 95% relative humidity. A first block was removed from the humidity chamber for analysis after 1 week. A second block was removed after 1 month. The third and final block was removed and analyzed after 3 months. When removed, the blocks were each dried and then visually analyzed for fungal growth.

The degree of internal borate diffusion was also visually analyzed using the curcumin method described by Smith and Williams in J. Inst. Wood. Sci. 4, 3-10 (1969). In brief, a dry cross section of the wood is first treated with curcumin and then with salicylic acid. Following these treatments, a color change is observed. Portions of the wood containing borates appear red while portions of the wood in which no or very low borate concentration are present appear yellow.

The first block, removed after one week, showed a little fungal growth and no significant borate movement by diffusion (radially or tangentially), although some longitudinal movement along the grain to the bottom of the blocks was evident, probably by initial adsorption.

In the second and third blocks (removed after one month and three months, respectively) there was a progressive increase in fungal growth. At least 5 different fungal morphologies were found with at least two molds being tentatively identified as Aspergillus sp. and Trichoderma sp. A third was identified as probably being a Basidiomycete, causing brown stains in the wood with an off white leathery mycelium. The side and bottom surfaces of the blocks were well covered with fungal activity, and on the top surface, the fungal activity was observed from the outside edge into the middle to a depth of about 10 to 15 mm.

A progressive increase in borate penetration by diffusion in a radial/tangential direction was also observed. The diffusion pattern was quite spectacular, especially at 3 months with an hour glass shape and penetration to about 10 mm from the outside edge in the middle of the block. Both the fungal and especially the diffusion pattern clearly demonstrates the presence of borate in a concentration gradient from very high in the center to low and then to nothing at the outside edge.

### Example 4

### Comparison of Fungal Growth and Decay (Wood Rot) in Treated and Untreated Rubber Wood Blocks

In this example, rubber wood (Hevea braziliensis) cylindrical blocks designed to attract termites, each measuring 62 mm diameter by 72 mm length, (weighing approximately 150 g) were used. One set was injected with approximately 1.5 ml of a 40 weight percent disodium octaborate tetrahydrate (DOT), poly glycol composition (commercially available as Bora-Care, EPA registration No.: 64405-1) into a central hole to give a high concentration reservoir but an overall weight retention of 0.4% DOT on a dry weight basis. One set was pressure treated to the same weight retention (but more uniform distribution and one set was left untreated as controls. Each block also had 4 termite feeding tracks 3 mm wide and 5 mm deep cut longitudinally on each compass point of the block along the longest surface, 5 replicates of each type were then placed in plastic cages and were buried in a mulched clay type soil in Knoxville, Tenn., for about one year.

Each of the 5 rubber wood blocks was weighed before being placed in the ground. After approximately one year, the blocks were removed from the ground and those without termite damage were weighed again to record the weight loss due to fungal decay of the wood. The mean weight loss percentages were as follows:

| Rubber Wood Block | Treatment Applied | Percent Weight Loss |
|---|---|---|
| 1 | Borate Injected Reservoir | 15% |
| 2 | Borate Pressure Treated | 13% |
| | (Uniform Treatment) | |
| 3 | Untreated (control) | 37% |

It may be seen that the weight loss in the rubber wood blocks treated with borate by injection was comparable to that of the pressure treated block (15% versus 13%). Both the borate treatments substantially reduced the amount of fungal decay as compared to the untreated control block. The treatment by injection and pressure treatment are advantageous over untreated wood as they will last much longer in use before requiring replacement even if not attacked by termites.

### Example 5

### Comparison of Termite Attack on Treated and Untreated Rubber Wood Blocks

In this example, rubber wood (Hevea braziliensis) cylindrical blocks designed to attract termites, each measuring 62 mm diameter by 72 mm length, (weighing approximately 150 g) were used. One set was injected with approximately 1.5 ml of a 40 weight percent disodium octaborate tetrahydrate (DOT), poly glycol composition (commercially available as Bora-Care, EPA registration No.: 64405-1) into a central hole to give a high concentration reservoir but an overall weight retention of 0.4% DOT on a dry weight basis. One set was pressure treated to the same borate weight retention (but with a more uniform distribution of the borate within the wood) and one set was left untreated as controls. Each block also had 4 termite feeding tracks 3 mm wide and 5 mm deep cut longitudinally on each compass point of the block along the longest surface, 5 replicates of each type were then placed in plastic cages and were buried in a mulched clay type soil in Knoxville, Tenn., for one year.

After approximately one year, the blocks were removed from the ground and inspected for signs of termite attack. It was found that 2 of the 5 untreated blocks were attacked by termites and 2 of the 5 samples treated by injection were also attacked by termites, but that none of the 5 samples pressure treated with borates were attacked by termites. This demonstrates that the presence of borates on the outside of the pressure treated baits was repellent to termites and deterred feeding. On the other hand, by placing the borates in the middle of the baits and allowing the borates to diffuse outward through the wood, the outer surface of the wood was not repellent to the termites. Thus, it was possible to trick the termites into eating these baits and ingesting the toxicant.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A termite bait station comprising:
a bait article comprising a cellulosic material, the bait article having a first end surface and a second end surface, an outer surface, and at least one insecticide reservoir disposed within the cellulosic material of the bait article, and
an insecticide-fungicide mixture disposed within the insecticide reservoir,
wherein at least a portion of the insecticide-fungicide mixture diffuses from the reservoir into the wood of the bait article.

2. The termite bait station of claim 1, wherein the cellulosic material comprises at least one type of wood selected from the group consisting of rubber wood, spruce wood, aspen wood, pine wood, poplar wood, sweet gum wood, eucalyptus wood and mango wood.

3. The termite bait station of claim 1, wherein the bait article is generally cylindrical in shape, having a diameter of from about 10 mm to about 300 mm and a height of from about 10 mm to about 300 mm.

4. The termite bait station of claim 1, wherein the bait article has an oven dry weight of from about 50 grams to about 2000 grams.

5. The termite bait station of claim 1, having at least one termite feeding channel disposed in the outer surface of the bait article.

6. The termite bait station of claim 5, wherein the termite feeding channel has a cross-sectional area of from about 1 to about 10 square millimeters.

7. The termite bait station of claim 1, wherein the insecticide-fungicide mixture comprises a first active component which functions as an insecticide and a second active component which functions as a fungicide.

8. The termite bait station of claim 1, wherein the insecticide-fungicide mixture comprises an active component which functions as both an insecticide and as a fungicide.

9. The termite bait station of claim 8, wherein the insecticide-fungicide mixture comprises at least one form of borate selected from the group consisting of boric acid, boric oxide, metal borate salts, non-metallic borate compounds, and mixtures thereof.

10. The termite bait station of claim 8, wherein the insecticide-fungicide mixture comprises from about 0.05 to about 0.45 weight percent disodium octaborate tetrahydrate.

11. The termite bait station of claim 8, wherein the insecticide-fungicide mixture further comprises at least hygroscopic agent selected from the group consisting of
ethylene glycol, diethylene glycol, triethylene glycol, polyethylene glycol, propylene glycol, dipropylene glycol, tripropylene glycol, tetrapropylene glycol, polypropylene glycol, glycerine, and mixtures thereof.

12. The termite bait station of claim 1, wherein the insecticide reservoir comprises one or more cavities disposed within the bait article having a total volume of from about 0.05 to about 60 milliliters.

13. The termite bait station of claim 1, wherein the diffusion of the insecticide-fungicide mixture provides a concentration in the wood at the outer surface of the bait article which is substantially nonrepellant to termites and a concentration in at least a portion of the interior wood of the bait article which is substantially toxic to termites.

14. A method for reducing termite infestation comprising:
positioning a plurality of termite bait stations within an area which is infested with termites,
wherein each of the termite bait stations comprises a bait article comprising a cellulosic material, the bait article having a first end surface and a second end surface, an outer surface, and at least one insecticide reservoir disposed within the cellulosic material of the bait article, and an insecticide-fungicide mixture disposed within the insecticide reservoir, the insecticide-fungicide mixture comprising at least one form of borate,
wherein at least a portion of the insecticide-fungicide mixture diffuses from the reservoir into the wood of the bait article and
wherein termites consume at least a portion of the wood from the bait article and thereby ingest a toxic amount of borates.

15. The method of claim 14, wherein the cellulosic material comprises at least one type of wood selected from the group consisting of rubber wood, spruce wood, aspen wood, pine wood, poplar wood, sweet gum wood, eucalyptus and mango wood.

16. The method of claim 14, wherein the bait article is generally cylindrical in shape, having a diameter of from about 10 mm to about 300 mm and a height of from about 10 mm to about 300 mm.

17. The method of claim 14, wherein the bait article has an oven dry weight of from about 50 grams to about 2000 grams.

18. The method of claim 14, having at least one termite feeding channel disposed in the outer surface of the bait article.

19. The method of claim 18, wherein the termite feeding channel has a cross-sectional area of from about 1 to about 10 square millimeters.

20. The method of claim 14, wherein the insecticide-fungicide mixture comprises a first active component which functions as an insecticide and a second active component which functions as a fungicide.

21. The method of claim 14, wherein the insecticide-fungicide mixture comprises an active component which functions as both an insecticide and as a fungicide.

22. The method of claim 20, wherein the insecticide-fungicide mixture comprises at least one form of borate selected from the group consisting of boric acid, boric oxide, metal borate salts, non-metallic borate compounds, and mixtures thereof.

23. The method of claim 20, wherein the insecticide-fungicide mixture comprises from about 0.05 to about 0.45 weight percent disodium octaborate tetrahydrate.

24. The method of claim 20, wherein the insecticide-fungicide mixture further comprises at least hygroscopic agent selected from the group consisting of ethylene glycol, diethylene glycol, triethylene glycol, polyethylene glycol, propylene glycol, dipropylene glycol, tripropylene glycol, tetrapropylene glycol, polypropylene glycol, glycerine, and mixtures thereof.

25. The method of claim 14, wherein the insecticide reservoir comprises one or more cavities disposed within the bait article having a total volume of from about 5 to about 6000 milliliters.

26. The method of claim 14, wherein the diffusion of the insecticide-fungicide mixture provides a termiticide concentration in the wood at the outer surface of the bait article which is substantially nonrepellant to termites and a termiticide concentration in at least a portion of the interior wood off the bait article which is substantially toxic to termites.

27. A termite bait station comprising:
a bait article comprising a cellulosic material, the bait article having a first end surface and a second end surface, an outer surface, at least one insecticide reservoir disposed within the cellulosic material of the bait article, and, and a plurality of termite feeding channels disposed in the outer surface,
wherein each of the termite feeding channels has a cross-sectional area of from about 1 to about 10 square millimeters and the at least one insecticide reservoir has a total volume of from about 0.05 to about 60 milliliters; and
an insecticide-fungicide mixture disposed within the insecticide reservoir, the insecticide-fungicide mixture comprising at least one form of borate,
wherein at least a portion of the insecticide-fungicide mixture diffuses from the reservoir into the cellulosic material of the bait article.

28. The termite bait station of claim 27, wherein the cellulosic material comprises wood.

29. The termite bait station of claim 27, wherein the cellulosic material comprises wood from the Hevea brasiliensis tree.
